(19) United States
(12) Patent Application Publication
(10) Pub. No.: US 2007/0085975 A1
(43) Pub. Date: Apr. 19, 2007

(54) LIGHT SPLITTING SYSTEM AND PROJECTOR INCORPORATING THE SAME

(75) Inventor: Chih-Chang Chou, Taipei County (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ CORPORATION, Taoyuan Shien (TW)

(21) Appl. No.: 11/531,781

(22) Filed: Sep. 14, 2006

(30) Foreign Application Priority Data
Oct. 13, 2005 (TW) 94135773

(51) Int. Cl. G03B 21/00

(52) U.S. Cl. 353/31

(57) ABSTRACT

A light splitting system and a projector incorporating the same are provided. The light splitting system includes an illumination device, a reflective mirror, a first color splitting device and a second color splitting device. The illumination device is for generating a light. The reflective mirror is for reciprocating between a first position and a second position to reflect the light. The first color splitting device is for receiving the light from the reflective mirror when the reflective mirror is located at the first position, and then filtering the light into a first primary-color light. The second color splitting device is for receiving the light from the reflective mirror when the reflective mirror is located at the second position, and then filtering the light into a second primary-color light.

This application claims the benefit of Taiwan application Serial No. 94135773, filed Oct. 13, 2005, the subject matter of which is incorporated herein by reference.

### BACKGROUND OF THE INVENTION

1. Field of the Invention

The invention relates in general to a light splitting system, and more particularly to a light splitting system using a color splitting device to filter the light into three colors of primary-color light (such as RGB) to be further processed by other optical elements of a projector.

2. Description of the Related Art

Along with the advance in technology, projector has become an indispensable projecting device in office, conference room, and other venues.

Referring to FIG. 1, a diagram of partial structure of a conventional projector is shown. The projector 100 includes an illumination device 110, a color wheel 120 and a light integrator 130. The illumination device 110 includes a light source 111 and a reflective holder 112.

Generally speaking, the projector 100 reflects the light emitted by the light source 111 to the color wheel 120 via the reflective holder 112, and then the light is split into three colors of primary-color light by the color wheel 120. The three colors of primary-color light, after having been received and equalized by the light integrator 130, are further processed by other optical elements such as a digital micromirror device (DMD).

However, the manufacturing cost of the color wheel used for splitting the light is expensive. Furthermore, when the color wheel is applied in a projector, the overall size of the projector and the disposition of the internal elements thereof are difficult to be adjusted due to optical paths between the color wheel and other optical elements being lack of versality. Therefore, how to design a substitute device which achieves the same splitting effect but with more versatile optical paths has become an imminent challenge.

### SUMMARY OF THE INVENTION

It is therefore an object of the invention to provide a light splitting system and projector incorporating the same. The design of incorporating a reflective mirror and a color splitting device enables the light to be filtered into different colors of primary-color light, thus achieving light splitting and saving costs. Besides, the optical path is more versatile.

The invention achieves the above-identified object by providing a light splitting system. The light splitting system includes an illumination device, a reflective mirror, a first color splitting device and a second color splitting device. The illumination device is for generating a light. The reflective mirror is for reciprocating between a first position and a second position to reflect the light. The first color splitting device is for receiving the light from the reflective mirror when the reflective mirror is located at the first position, and then filtering the light into a first primary-color light. The second color splitting device is for receiving the light from the reflective mirror when the reflective mirror is located at the second position, and then filtering the light into a second primary-color light.

The invention further achieves the above-identified object by providing a projector. The projector includes a light splitting system and an optical element. The light splitting system includes an illumination device, a reflective mirror, a first color splitting device and a second color splitting device. The illumination device is for generating a light. The reflective mirror is for reciprocating between a first position and a second position to reflect the light. The first color splitting device is for receiving the light from the reflective mirror when the reflective mirror is located at the first position, and then filtering the light into a first primary-color light. The second color splitting device is for receiving the light from the reflective mirror when the reflective mirror is located at the second position, and then filtering the light into a second primary-color light. The optical element is for respectively receiving the first primary-color light and the second primary-color light.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a diagram of partial structure of a conventional projector; and

FIGS. 2A˜2C are three diagrams illustrating the projector according to a preferred embodiment of the invention generates three colors of primary-color light in the light splitting system.

### DETAILED DESCRIPTION OF THE INVENTION

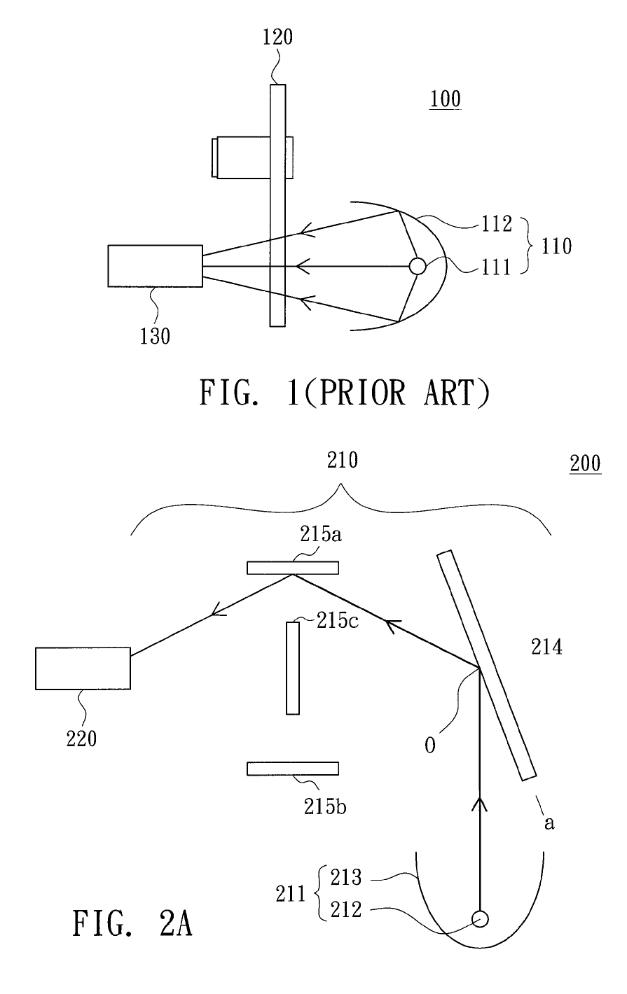

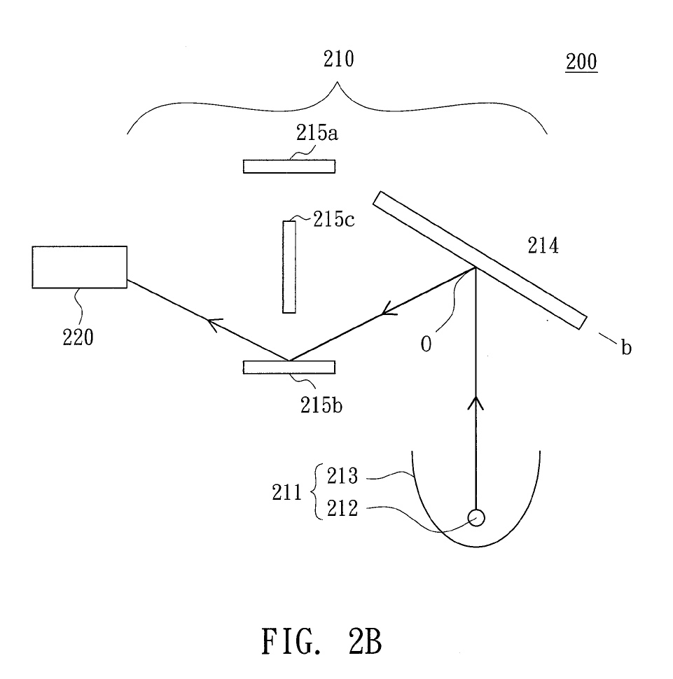

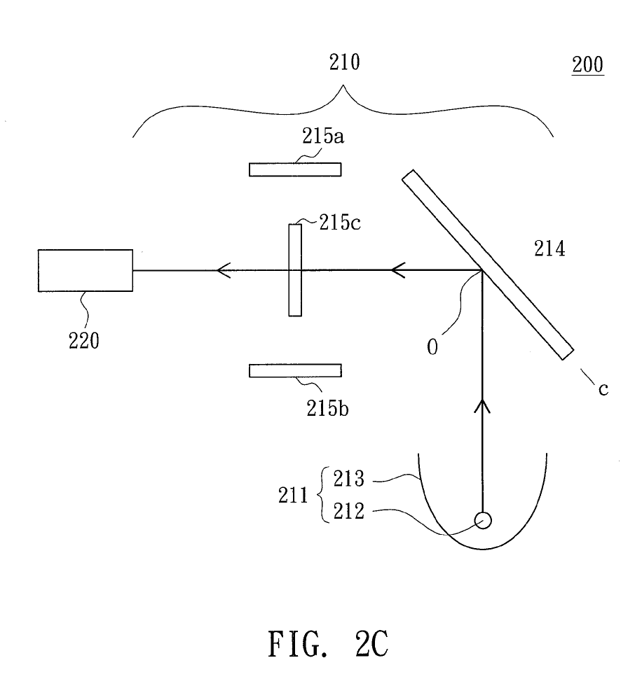

Referring to FIGS. 2A˜2C, three diagrams illustrating the projector according to a preferred embodiment of the invention generates three colors of primary-color light in the light splitting system are shown. The projector 200 includes a light splitting system 210 and an optical element 220. The light splitting system 210 includes an illumination device 211, a reflective mirror 214, a first color splitting device 215a, a second color splitting device 215b and a third color splitting device 215c. The illumination device 211 is for generating a light. The reflective mirror 214 is for reciprocating among a first position a, a second position b and a third position c to reflect the light. The first color splitting device 215a is for receiving the light from the reflective mirror 214 when the reflective mirror 214 is positioned at the first position a, and then filtering the light into a first primary-color light. The second color splitting device 215b is for receiving the light from the reflective mirror 214 when the reflective mirror 214 is positioned at the second position b, and then filtering the light into a second primary-color light. The third color splitting device 215c is for receiving the light from the reflective mirror 214 when the reflective mirror 214 is positioned at the third position c, and then filtering the light into a third primary-color light. The optical element 220 is for respectively receiving the first primary-color light, the second primary-color light and the third primary-color light.

Besides, the first color splitting device 215a is a first filter reflective mirror, for reflecting the light into the first primary-color light. The second color splitting device 215b is a second filter reflective mirror or a first filter lens for reflecting or filtering the light into the second primary-color light. The third color splitting device 215c is a second filter lens for filtering the light into the third primary-color light. In the present embodiment of the invention, the first color splitting device 215a, the second color splitting device 215b and the third color splitting device 215c are exemplified by the first filter reflective mirror, the second filter reflective mirror and the filter lens respectively.

Moreover, the illumination device 211 includes a light source 212 and a reflective holder 213. The light source 212 is for generating a light. The reflective holder 213 at least covers part of the periphery of the light source 212 to reflect the light generated by the light source 212 onto the reflective mirror 214. Examples of the optical element 220 includes a light integrator, a light pipe, a light tunnel, a digital micromirror device (DMD) or a liquid crystal display (LCD) panel. The first primary-color light, the second primary-color light and the third primary-color light are a combination of a red (R) light, a green (G) light and a blue (B) light.

As for how the light splitting system 210 generates three colors of primary-color light is exemplified below. However, the technology of the present embodiment of the invention is not limited thereto.

As shown in FIG. 2A, when the light splitting system 210 generates a first primary-color light, the reflective mirror 214 is rotated to the first position a around the pivotal shaft O. Meanwhile, the light generated by the light source 212 is reflected to the reflective mirror 214 via the reflective holder 213, then the reflective mirror 214 reflects the light onto the first color splitting device 215a. Next, the first color splitting device 215a reflects the light into the first primary-color light to be projected onto the receiving terminal of the optical element 220.

As shown in FIG. 2B, when the light splitting system 210 generates a second primary-color light, the reflective mirror 214 is rotated to the second position b around the pivotal shaft O. Meanwhile, the light generated by the light source 212 is reflected to the reflective mirror 214 via the reflective holder 213, then the reflective mirror 214 reflects the light onto the second color splitting device 215b. Next, the second color splitting device 215b reflects the light into the second primary-color light to be projected onto the receiving terminal of the optical element 220. In the present embodiment of the invention, the first color splitting device 215a is substantially parallel to the second color splitting device 215b.

As shown in FIG. 2C, when the light splitting system 210 generates a third primary-color light, the reflective mirror 214 is rotated to the third position c around the pivotal shaft O. Meanwhile, the light generated by the light source 212 is reflected to the reflective mirror 214 via the reflective holder 213, then the reflective mirror 214 reflects the light onto the third color splitting device 215c. Next, the third color splitting device 215c filters the light into the third primary-color light to be projected onto the receiving terminal of the optical element 220. In the present embodiment of the invention, the third color splitting device 215c is disposed between the first color splitting device 215a and the second color splitting device 215b, and is substantially perpendicular to the first color splitting device 215a and the second color splitting device 215b. After the receiving terminal of the optical element 220 receives the above three colors of primary-color light, the light is optically processed and then transmitted out by the transmitting terminal of the optical element 220.

After the light splitting system 210 filters the light into the first primary-color light, the second primary-color light and the third primary-color light, the light is received by the optical element 220 for further processing.

Despite the light splitting system 210 of the present embodiment of the invention is exemplified by being disposed on the projector 200, the light splitting system 210 of the present embodiment of the invention is applicable to other electronic devices, such as back-projection TV, requiring the light to be filtered into at least a primary-color light. Furthermore, the light splitting system 210 of the present embodiment of the invention at least filters the light into at least a primary-color light through the design of incorporating the reflective mirror and the color splitting device.

Any one who is skilled in the technology of the technology of the invention will understand that the technology of the invention is not limited thereto. For example, when the position of reflective mirror 214 is fixed, the incident angle of the light generated by the illumination device 211 on the reflective mirror 214 can be made different by shifting the position of the illumination device 211. Therefore, when the reflective mirror 214 receives the light provided by the illumination device 211 from different positions, the reflective mirror 214 is still able to reflect the light to the first color splitting device 215a, the second color splitting device 215b and the third color splitting device 215c, and achieve the same light splitting effect.

The light splitting system and projector incorporating the same disclosed in the above embodiment of the invention splits the light by filtering the light into different colors of primary-color light through the design of incorporating the reflective mirror and the color splitting device, not only reducing the manufacturing cost but also providing more versatile optical paths.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A light splitting system, comprising:
an illumination device for generating a light;
a reflective mirror for reciprocating between a first position and a second position to reflect the light;
a first color splitting device for receiving the light from the reflective mirror when the reflective mirror is positioned at the first position and then filtering the light into a first primary-color light; and
a second color splitting device for receiving the light from the reflective mirror when the reflective mirror is positioned at the second position and then filtering the light into a second primary-color light.

2. The light splitting system according to claim 1, wherein the reflective mirror is rotated around a pivotal shaft.

3. The light splitting system according to claim 1, wherein the first color splitting device is a first filter reflective mirror for reflecting the light into the first primary-color light.

4. The light splitting system according to claim 3, wherein the second color splitting device is a second filter reflective mirror or a first filter lens for reflecting or filtering the light into the second primary-color light.

5. The light splitting system according to claim 4, wherein the reflective mirror reciprocates between the first position and a third position to reflect the light, the light splitting system further comprises a third color splitting device for receiving the light from the reflective mirror when the reflective mirror is positioned at the third position and then filtering the light into a third primary-color light.

6. The light splitting system according to claim 5, wherein the third color splitting device is a second filter lens for filtering the light into the third primary-color light.

7. The light splitting system according to claim 6, wherein the first filter reflective mirror and the second filter reflective mirror are substantially in parallel and respectively perpendicular to the second filter lens.

8. The light splitting system according to claim 5, wherein the first primary-color light, the second primary-color light and the third primary-color light are a combination of a red (R) light, a green (G) light and a blue (B) light.

9. The light splitting system according to claim 1, wherein the illumination device comprising:
a light source for generating the light; and
a reflective holder at least covering part of the periphery of the light source to reflect the light generated by the light source onto the reflective mirror.

10. A projector, comprising:
a light splitting system, comprising:
an illumination device for generating a light;
a reflective mirror for reciprocating between a first position and a second position to reflect the light;
a first color splitting device for receiving the light from the reflective mirror when the reflective mirror is at the first position and then filtering the light into a first primary-color light; and
a second color splitting device for receiving the light from the reflective mirror when the reflective mirror is at the second position and then filtering the light into a second primary-color light; and
an optical element for respectively receiving the first primary-color light and the second primary-color light.

11. The projector according to claim 10, wherein the reflective mirror is rotated around a pivotal shaft.

12. The projector according to claim 10, wherein the first color splitting device is a first filter reflective mirror for reflecting the light into the first primary-color light.

13. The projector according to claim 12, wherein the second color splitting device is a second filter reflective mirror or a first filter lens for reflecting or filtering the light into the second primary-color light.

14. The projector according to claim 13, wherein the reflective mirror reciprocates between the first position and a third position to reflect the light, the light splitting system further comprises a third color splitting device for receiving the light from the reflective mirror when the reflective mirror is at the third position and then filtering the light into a third primary-color light to be received by the optical element.

15. The projector according to claim 14, wherein the third color splitting device is a second filter lens for filtering the light into the third primary-color light.

16. The projector according to claim 15, wherein the third color splitting device is disposed between the reflective mirror and the optical element and positioned between the first color splitting device and the second color splitting device.

17. The projector according to claim 15, wherein the first filter reflective mirror and the second filter reflective mirror are substantially in parallel and respectively perpendicular to the second filter lens.

18. The projector according to claim 14, wherein the first primary-color light, the second primary-color light and the third primary-color light are a combination of a red (R) light, a green (G) light and a blue (B) light.

19. The projector according to claim 10, wherein the optical element comprises a light integrator, a light pipe, a light tunnel, a digital micromirror device (DMD) or a liquid crystal display (LCD) panel.

20. The projector according to claim 10, wherein the illumination device comprises:
a light source for generating the light; and
a reflective holder at least covering part of the periphery of the light source to reflect the light generated by the light source onto the reflective mirror.
